(19) United States
(12) Patent Application Publication
(10) Pub. No.: US 2026/0307703 A1
(43) Pub. Date: Oct. 8, 2026

(54) Dual-Storage Structure for a Shopping Cart

(71) Applicant: Maplebear Inc., San Francisco, CA (US)

(72) Inventors: Trevor Timson, Chicago, IL (US); Elizabeth Ferrall-Nunge, Oakland, CA (US); Linhua Luo, Shanghai (CN); YanYing Tai, Shanghai (CN); Yilin Huang, Shanghai (CN); Graham Beauregard, Burlington (CA); Weiting Chen, Shanghai (CN); Jianbo Meng, Shanghai (CN); Sai Shi, Shanghai (CN); Donghui Sheng, Shanghai (CN); Matas Rimas Sriubiskis, Toronto (CA)

(21) Appl. No.: 19/641,183

(22) Filed: Apr. 7, 2026

Related U.S. Application Data
(60) Provisional application No. 63/785,460, filed on Apr. 8, 2025.

(51) Int. Cl. B62B 5/00; B62B 3/14; G01G 19/393; G01G 19/52; G06T 7/70

(52) U.S. Cl. CPC B62B 5/0096; B62B 3/1468; G01G 19/393; G01G 19/52; G06T 7/70

(57) ABSTRACT

A shopping cart includes a dual storage structure that defines an upper storage area and lower storage area of the shopping cart. The contents of both storage areas may be weighed by measuring the weight of the dual storage structure using load sensors. A shopping cart includes a camera coupled to its frame such that a lower storage area of the shopping cart is in the field of view of the camera. The shopping cart captures images of items in the storage area and applies an item-detection algorithm to portions of the image to detect items. A shopping cart includes a primary display and a secondary display. The shopping cart generates a primary user interface (UI) and generates a secondary UI based on content of the primary UI. Primary UI elements are included in the generated secondary UI based on sensor data of the shopping cart.

### CROSS REFERENCE TO RELATED APPLICATIONS

This application claims the benefit of U.S. Provisional Patent Application Ser. No. 63/785,460, filed Apr. 8, 2025, which is incorporated by reference herein in its entirety.

### BACKGROUND

Smart shopping carts are shopping carts that include computational functionality to detect items that users add to storage areas and to present content to users on a display. These carts may include sensors that collect data to be used in item identification. For example, a smart shopping cart may use images from cameras coupled to the cart to decode machine-readable codes on items or may use proximity sensor data to detect when an item has been added.

Smart shopping carts may further include load sensors that measure a load imparted by items on the frame of the shopping cart. These load sensors may be coupled to a main storage structure (e.g., a basket) of the shopping cart and may capture load measurements that describe the load of the items on the basket. However, shopping carts may have more than one storage structure, such as an upper basket and a lower tray. Where load sensors are only coupled to one of the storage structures, the shopping cart does not collect load sensor data from items in the other storage areas.

A shopping cart may simply include additional load sensors to measure the load of items added to the other storage structures. However, the configuration of the storage structures cause challenges with accurately measuring the load imparted by items. For example, bulky items in a lower storage area may press upward against an upper storage structure. In this case, some of the load of the upper storage structure may transfer to the load sensors for the lower storage structure, which can lead to erroneous readings for the load sensors for both storage structures.

Furthermore, as noted above, shopping carts may use images captured by cameras to identify items added to the shopping cart. These cameras may be mounted over an upper storage area of the shopping cart with a field of view of the upper storage area. By capturing image data depicting an item that a user adds to a storage area of the shopping cart, the shopping cart may apply an item-detection algorithm to images to identify items that are added to and removed from a storage area. However, image-based item detection is challenging for lower storage areas. Even if the camera is beneath the upper storage structure, an item placed in the lower storage area may block the field of view of the camera. Items later added to the lower storage area are then occluded by the item and are not in view of the camera.

Furthermore, these shopping carts may include a display to present information for a user and others in the surrounding environment. These displays may present a user interface with content relating to the user's interactions with the shopping cart. Users may predominantly be positioned at the rear of the shopping cart because they may be controlling the shopping cart using a handlebar. Thus, shopping cart displays may generally face the rear of the shopping cart such that it displays content to the user as they navigate the shopping cart through the environment.

While a rear-facing configuration of the display allows the user to see information on the display for the majority of their shopping trip, the display is out of view when the user is near the front or sides of the shopping cart. As such, information related to their use of the shopping cart is commonly inaccessible to the user. This limits the functionality of the display and prevents the user from seeing relevant information in a timely manner.

### SUMMARY

A smart shopping cart includes a dual storage structure that allows for measuring the load of items added to an upper or lower storage structure of the shopping cart through one set of load sensors. A dual storage structure is a singular structure for an upper storage area and lower storage area of the shopping cart. The dual storage structure may include an upper storage structure and a lower storage structure that are coupled to each other through a connecting member.

The shopping cart includes load sensors that are coupled to the dual storage structure such that the load sensors, together, measure the total load of the dual storage structure on the frame of the shopping cart. The total load includes a load of the dual storage structure itself as well as a load of items contained within the storage areas of the dual storage structure. The on-cart computing system of the shopping cart is communicatively coupled to the load sensors such that the on-cart computing system receives signals representing the measurements of the total load from the load sensors. The dual storage structure of the shopping cart allows the on-cart computing system to measure the contents stored in both storage areas of the shopping cart.

The rigid connection between the upper and lower storage structures results in a dual storage structure that collectively contains and supports all items added to the shopping cart. Regardless of whether an item is added to the upper or lower storage structures of the shopping cart, the item's load is measured in the total contents of the shopping cart. Therefore, the dual storage structure solves the technical problem of bulky items causing erroneous readings for shopping carts with separately measured storage areas by implementing a dual storage structure which can be collectively weighed. Furthermore, by measuring the load of the dual storage structure as a whole, the shopping cart can measure the load of items added to an upper or lower storage area using fewer load sensors than if load sensors were used for each area.

Additionally, the shopping cart may include a lower camera that is used to identify items that are placed in a lower storage area of the shopping cart. The lower camera may be coupled to the frame such that the lower storage structure is in the field of view of the lower camera. The shopping cart may also include an upper camera that is coupled to the frame such that an upper storage structure is in the field of view of the upper camera.

The shopping cart detects items added to the lower storage area using the lower camera. The shopping cart may capture a series of images over a time period using the lower camera. The series of images depict an item being added to the lower storage area of the shopping cart. Each image of the series of images depicts the lower storage area of the shopping cart and the environment around the lower storage area. The shopping cart attempts to detect and identify items added to the lower storage area using the portion of the image depicting the lower storage area captured by the lower camera. In an initial attempt to detect an item, the shopping cart applies an item-detection algorithm to the portion of the image depicting the lower storage area. The item-detection algorithm outputs a predicted item identifier for the item and an associated confidence score. The shopping cart can use the confidence score output with the predicted item identifier to determine whether the shopping cart has sufficient information to correctly identify the item.

If the confidence score does not exceed the threshold value, the shopping cart will attempt to identify the item as it approaches the lower storage area by applying the item-detection algorithm to an earlier image in the series of images captured by the lower camera. The shopping cart may apply a similar process to the earlier image as to the original image to generate a new predicted item identifier and a new confidence score. The shopping cart may apply the item-detection algorithm to the earlier image by itself or may apply the algorithm to both images together. The shopping cart determines whether it can identify the item using the new predicted item identifier based on the confidence score with the new item identifier. If the shopping cart still cannot identify the item based on the additional image(s) from the lower camera, the shopping cart may use images captured by an upper camera of the shopping cart. For example, the shopping cart may apply the item-detection algorithm to one or more images captured by the upper camera to generate another predicted item identifier and confidence score. The shopping cart may use the confidence score from the upper camera images to determine whether it can accurately identify the item. If the confidence score exceeds a threshold value, the shopping cart uses the predicted item identifier to update a display of the shopping cart to include content relating to the item of the predicted item identifier.

By using additional images captured by a lower camera or an upper camera when the shopping cart cannot identify an item based on a single image, the shopping cart can identify an item as the user places the item in a lower storage area. Thus, the shopping cart can still identify items if another item in the lower storage area is occluding the lower camera. Furthermore, by iteratively increasing the number of images used for identifying the item, the shopping cart reduces the usage of its limited computational resources in item identification.

Furthermore, the shopping cart may include a secondary display that presents supplemental content relating to a user's interactions with the shopping cart. The secondary display may face towards an upper storage area of the shopping cart, whereas a primary display may face towards the rear of the shopping cart. The secondary display may display content based on the content presented on the primary display. For example, the on-cart computing system may select a subset of content shown on the primary display to display on the secondary display.

In some embodiments, the shopping cart selects a UI pane presented on the primary display to be presented on the secondary display. For example, the primary display may present a primary UI containing UI panes that relate to a user's interaction with the shopping cart. For example, the primary display may contain UI panes that describe items that the user has added to storage areas of the shopping cart or navigation information to a location that the user has searched for. The shopping cart selects which of the UI panes to display on the secondary display and may modify the selected UI pane for presentation on the secondary display. For example, the shopping cart may add, remove, or replace content from the UI pane on the primary display for presentation on the secondary display.

By selecting a UI pane from the primary display for presentation on the secondary display, the shopping cart maintains a cohesive user experience between the primary and secondary displays. Furthermore, the shopping cart reduces the computational load of generating content for display to a user by reusing content displayed on the primary display for the secondary display.

### BRIEF DESCRIPTION OF DRAWINGS

FIG. 1 illustrates an example environment of a smart shopping cart system, in accordance with some embodiments.

FIG. 2 illustrates an example smart shopping cart including a dual storage structure, in accordance with some embodiments.

FIG. 3 illustrates an exploded view of an example smart shopping cart including an upper storage structure and a lower storage structure, in accordance with some embodiments.

FIG. 4 illustrates a side view of an example smart shopping cart including an upper camera and a lower camera in view of an upper storage area and a lower storage area, respectively, of a dual storage structure, in accordance with some embodiments.

FIG. 5 is a flowchart showing a process for predicting an item identifier of an item added to a lower storage area of a shopping cart by applying an item-detection algorithm to images captured by a lower camera, in accordance with some embodiments.

FIG. 6 is a flowchart showing a process for predicting an item identifier of an item added to a lower storage area of a shopping cart by applying an item-detection algorithm to images captured by a lower camera and an upper camera, in accordance with some embodiments.

FIGS. 7A and 7B illustrate an example smart shopping cart including a primary display and a secondary display, in accordance with some embodiments.

FIG. 8 is a flowchart showing an exemplary process for generating a secondary UI for a secondary display based on a UI pane selected from the primary UI, in accordance with some embodiments.

FIGS. 9A and 9B illustrate an example of a primary user interface displayed on a primary display and a corresponding secondary user interface containing a navigation user interface pane displayed on a secondary display, in accordance with some embodiments.

FIGS. 10A and 10B illustrate an example of a primary user interface displayed on a primary display and a corresponding secondary user interface containing an item list user interface pane displayed on a secondary display, in accordance with some embodiments.

### DETAILED DESCRIPTION

### Example System Environment For Smart Cart System

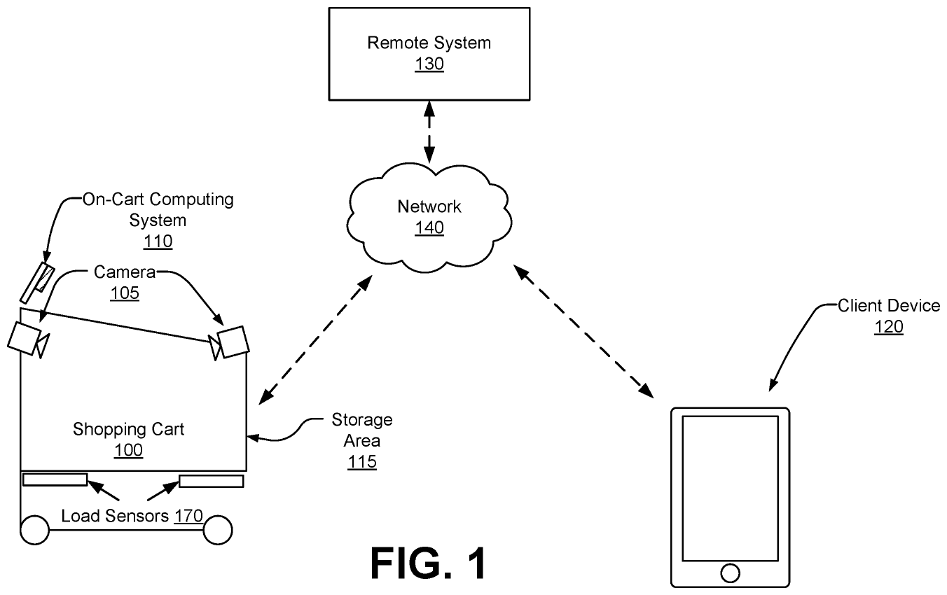

FIG. 1 illustrates an example system environment for a smart cart system, in accordance with one or more illustrative embodiments. The system environment illustrated in FIG. 1 includes a shopping cart 100, a client device 120, a remote system 130, and a network 140. Alternative embodiments may include more, fewer, or different components from those illustrated in FIG. 1, and the functionality of each component may be divided between the components differently from the description below. For example, functionality described below as being performed by the shopping cart may be performed, in some embodiments, by the remote system 130 or the client device 120. Similarly, functionality described below as being performed by the remote system 130 may, in some embodiments, be performed by the shopping cart 100 or the client device 120. Additionally, each component may perform their respective functionalities in response to a request from a human, or automatically without human intervention.

A shopping cart 100 is a vessel that a user can use to hold items as the user travels through a store. The shopping cart 100 includes one or more cameras 105 that capture image data of the shopping cart's storage area and a user interface that the user can use to interact with the shopping cart 100. The shopping cart 100 may include additional components not pictured in FIG. 1, such as processors, computer-readable media, power sources (e.g., batteries), network adapters, or sensors (e.g., load sensors, thermometers, proximity sensors).

The cameras 105 capture image data of the shopping cart's storage area. The cameras 105 may capture two-dimensional or three-dimensional images of the shopping cart's contents. The cameras 105 are coupled to the shopping cart 100 such that the cameras 105 capture image data of the storage area from different perspectives. Thus, items in the shopping cart 100 are less likely to be overlapping in all camera perspectives. In some embodiments, the cameras 105 include embedded processing capabilities to process image data captured by the cameras 105. For example, the cameras 105 may be mobile industry processor interface (MIPI) cameras. The cameras 105 may be set to capture images from the area surrounding the shopping cart including the user of the cart. In some embodiments, at least one of the cameras 105 is directed outward, away from the shopping cart 100.

In some embodiments, the shopping cart 100 captures image data in response to detecting that an item is being added to the storage area. The shopping cart 100 may detect that an item is being added to the storage area 115 of the shopping cart 100 based on sensor data from sensors on the shopping cart 100. For example, the shopping cart 100 may detect that a new item has been added when the shopping cart 100 (e.g., load sensors 170) detects a change in the overall weight of the contents of the storage area 115 based on load data from load sensors. Similarly, the shopping cart 100 may detect that a new item is being added based on proximity data from proximity sensors indicating that something is approaching the storage area of the shopping cart 100. The shopping cart 100 may capture image data within a timeframe near when the shopping cart 100 detects a new item. For example, the shopping cart 100 may activate the cameras 105 and store image data in response to detecting that an item is being added to the shopping cart 100 and for some period of time after that detection.

The shopping cart 100 may include one or more sensors that capture measurements describing the shopping cart 100, items in the shopping cart's storage area, or the area around the shopping cart 100. For example, the shopping cart 100 may include load sensors 170 that measure the weight of items placed in the shopping cart's storage area. Load sensors 170 are further described below. Similarly, the shopping cart 100 may include proximity sensors that capture measurements for detecting when an item is added to the shopping cart 100. The shopping cart 100 may transmit data from the one or more sensors to the remote system 130.

The one or more load sensors 170 capture load data for the shopping cart 100. In some embodiments, the one or more load sensors 170 may be scales that detect the weight (e.g., the load) of the content in the storage area 115 of the shopping cart 100. The load sensors 170 can also capture load curves-the load signal produced over time as an item is added to the cart or removed from the cart. The load sensors 170 may be attached to the shopping cart 100 in various locations to pick up different signals that may be related to items added at different positions of the storage area. For example, a shopping cart 100 may include a load sensor 170 at each of the four corners of the bottom of the storage area 115. In some embodiments, the load sensors 170 may record load data continuously while the shopping cart 100 is in use. In other embodiments, the shopping cart 100 may include some triggering mechanism, for example a light sensor, an accelerometer, or another sensor to determine that the user is about to add an item to the shopping cart 100 or about to remove an item from the shopping cart 100. The triggering mechanism causes the load sensors 170 to begin recording load data for some period of time, for example a preset time range.

The shopping cart 100 may include one or more wheel sensors (not shown) that measure wheel motion data of the one or more wheels. The wheel sensors may be coupled to one or more of the wheels on the shopping cart. In some embodiments, a shopping cart 100 includes at least two wheels (e.g., four wheels in the majority of shopping carts) with two wheel sensors coupled to two wheels. In further embodiments, the two wheels coupled to the wheel sensors can rotate about an axis parallel to the ground and can orient about an axis orthogonal or perpendicular to the ground. In other embodiments, each of the wheels on the shopping cart has a wheel sensor (e.g., four wheel sensors coupled to four wheels). The wheel motion data includes at least rotation of the one or more wheels (e.g., information specifying one or more attributes of the rotation of the one or more wheels). Rotation may be measured as a rotational position, rotational velocity, rotational acceleration, some other measure of rotation, or some combination thereof. Rotation for a wheel is generally measured along an axis parallel to the ground. The wheel rotation may further include orientation of the one or more wheels. Orientation may be measured as an angle along an axis orthogonal or perpendicular to the ground. For example, the wheels are at 0° when the shopping cart is moving straight and forward along an axis running through the front and the back of the shopping cart. Each wheel sensor may be a rotary encoder, a magnetometer with a magnet coupled to the wheel, an imaging device for capturing one or more features on the wheel, some other type of sensor capable of measuring wheel motion data, or some combination thereof.

The shopping cart 100 includes an on-cart computing system 110 that enables the user to perform an automated checkout through the shopping cart 100. The computing system includes a processor and a non-transitory computer-readable medium that stores instructions that may be executed by the processor. The computing system 110 also may include a display, a speaker, a microphone, a keypad, or a payment system (e.g., a credit card reader). The computing system 110 also includes a wireless network adapter that allows the computing system to communicate via the network 140.

The on-cart computing system 110 allows a customer at a brick-and-mortar store to complete a checkout process in which items are scanned and paid for without having to go through a human cashier at a point-of-sale station. The on-cart computing system 110 receives data describing a user's shopping trip in a store and generates a shopping list based on items that the user has selected. For example, the on-cart computing system 110 may receive data from cameras or sensors coupled to the shopping cart 100 and may determine, based on the data, which items the user has added to their cart.

The on-cart computing system 110 may use machine-learning models or computer-vision techniques to identify items that the user adds to the shopping cart. For example, the on-cart computing system 110 apply a barcode detection model to images captured by a camera of the shopping cart to identify items based on the barcodes that are visible to the camera. The barcode detection model is a machine-learning model (e.g., a neural network) that is trained to identify item identifiers that are encoded in barcodes that are depicted in image data. The barcode detection model may be trained based on a set of training examples. Each of the training examples may include an image of a barcode and a label that indicates what item identifier encoded by the barcode. In some embodiments, the on-cart computing system 110 preprocesses the image before applying the barcode detection model to the image. For example, the on-cart computing system may rotate the image so that the barcode is aligned with a set direction or may crop an image of an item to a portion of the image that depicts the barcode. U.S. patent application Ser. No. 17/703,076, entitled “Image-Based Barcode Decoding” and filed Mar. 24, 2022, describes an example barcode detection model in accordance with some embodiments and is incorporated by reference.

The on-cart computing system also may store and apply an optical character recognition (OCR) model to the image. An OCR model is a machine-learning model that converts typed, handwritten, or printed text depicted in images into machine-readable text. The on-cart computing system applies the OCR model to images captured by the cameras to identify items depicted in those images. For example, the on-cart computing system may generate a set of OCR text for an image. This OCR text is text that the OCR model has identified as being depicted in the image. The on-cart computing system uses the OCR text to identify items in images. For example, the on-cart computing system may apply another machine-learning model (e.g., a large language model) to the OCR text to predict which item is depicted in the image based on the OCR text.

In some embodiments, the on-cart computing system uses an item lookup table to identify items depicted in an image based on OCR text extracted from that image. The item lookup table stores a set of items that may be depicted in images captured by the cameras and corresponding text that is associated with each of the items. The on-cart computing system stores the item lookup table for use in identifying items. For example, the on-cart computing system may compare OCR text from an image to the corresponding text for each of the items to identify items depicted in images. The on-cart computing system may identify the item by identifying which item in the item lookup table has the most characters or words in common with the OCR text or which item has the longest sequence of characters in common with the OCR text. In some embodiments, rather than storing text in the item lookup table, the item lookup table stores embeddings that represent text associated with items. In these embodiments, the on-cart computing system may generate an embedding for OCR text and compare that embedding to the embeddings stored in the item lookup table to identify the item.

Furthermore, the on-cart computing system may store and apply an image embedding model to captured images to identify items. The image embedding model is a machine-learning model that is trained to generate embeddings for images captured by the cameras. The on-cart computing system applies the image embedding model to images captured by the cameras of the shopping cart and uses the embeddings to identify which items are depicted in the images. For example, the on-cart computing system may store embeddings that correspond to items that a user may place in the shopping cart. Each item may be associated with a single embedding or multiple embeddings. The on-cart computing system applies the image embedding model to images captured by the cameras and compares the generated embeddings to stored embeddings for items. The on-cart computing system identifies which item or items are depicted in an image based on how similar the generated embeddings are to the stored embeddings corresponding to the item(s). For example, the on-cart computing system may compute a distance, dot product, or cosine similarity between the embeddings to identify the item in the images. U.S. patent application Ser. No. 17/726,385, entitled “System for Item Recognition using Computer Vision” and filed Apr. 21, 2022, describes example methodologies for identifying items using a machine-learning model and is incorporated by reference.

Any of these models may be sensor fusion models that take sensor data as additional inputs. For example, a model may use weight data from a load sensor or proximity data from a proximity sensor as an additional input to predict an identifier for an item added to the shopping cart.

The on-cart computing system 110 generates a shopping list for the user as the user adds items to the shopping cart 100. The shopping list is a list of items that the user has gathered in the storage area 115 of the shopping cart 100 and intends to purchase. The shopping list may include identifiers for the items that the user has gathered (e.g., stock keeping units (SKUs)) and a quantity for each item. When the user indicates that they are done shopping at the store, the on-cart computing system 110 interfaces with the remote system 130 to facilitate a transaction between the user and the store for the user to purchase their selected items. For example, the on-cart computing system 110 may receive payment information from the user through a user interface and transmit that payment information to the remote system 130.

The user interface of the on-cart computing system 110 may allow the user to adjust the items in their shopping list or to provide payment information for a checkout process. Additionally, the user interface may display a map of the store indicating where items are located within the store. In some embodiments, a user may interact with the user interface to search for items within the store, and the user interface may provide a real-time navigation interface for the user to travel from their current location to an item within the store. The user interface also may display additional content to a user, such as suggested recipes or items for purchase. In some embodiments, the on-cart computing system 110 may receive content from the remote system 130 to display to the user. For example, the on-cart computing system may receive item recommendations, recipe recommendations, or brand recommendations from the remote system 130.

The on-cart computing system may include a tracking system configured to track a position, an orientation, movement, or some combination thereof of the shopping cart 100 in an indoor environment. The tracking system may further include other sensors capable of capturing data useful for determining position, orientation, movement, or some combination thereof of the shopping cart. Other example sensors include, but are not limited to, an accelerometer, a gyroscope, etc. The tracking system may provide real-time location of the shopping cart to an online system and/or database. The location of the shopping cart may inform content to be displayed by the user interface. For example, if the shopping cart 100 is located in one aisle, the display can provide navigational instructions to a user to navigate them to a product in the aisle. In other example use cases, the display can provide suggested products or items located in the aisle based on the user's location.

A user can also interact with the shopping cart 100 or the remote system 130 through a client device 120. The client device 120 can be a personal or mobile computing device, such as a smartphone, a tablet, a laptop computer, or desktop computer. In some embodiments, the client device 120 executes a client application that uses an application programming interface (API) to communicate with the remote system 130 through the network 140. The client device 120 may allow the user to add items to a shopping list and to checkout through the remote system 130. For example, the user may use the client device 120 to capture image data of items that the user is selecting for purchase, and the client device 120 may provide the image data to the remote system 130 to identify the items that the user is selecting. The client device 120 may adjust the user's shopping list based on the identified item. In some embodiments, the user can also manually adjust their shopping list through the client device 120.

In some embodiments, the on-cart computing system 110, the camera(s), and the sensors of the shopping cart are separately mounted to the shopping cart. Alternatively, the on-cart computing system 110, camera(s), and sensors may be contained within a single casing that is mounted to the shopping cart. This single casing may contain all of the components needed by the on-cart computing system 110 to perform the functionalities described herein. The single casing may be permanently mounted to the shopping cart or may be configured to be easily attached to or detached from the shopping cart. This latter embodiment may enable the on-cart computing system 110 to be recharged at a separate station from the shopping cart or may allow the computing system 110 to be easily mounted to pre-existing shopping carts, rather than requiring specially built shopping carts.

The shopping cart 100 and client device 120 can communicate with the remote system 130 via a network 140. The network 140 is a collection of computing devices that communicate via wired or wireless connections. The network 140 may include one or more local area networks (LANs) or one or more wide area networks (WANs). The network 140, as referred to herein, is an inclusive term that may refer to any or all of standard layers used to describe a physical or virtual network, such as the physical layer, the data link layer, the network layer, the transport layer, the session layer, the presentation layer, and the application layer. The network 140 may include physical media for communicating data from one computing device to another computing device, such as MPLS lines, fiber optic cables, cellular connections (e.g., 3G, 4G, or 5G spectra), or satellites. The network 140 also may use networking protocols, such as TCP/IP, HTTP, SSH, SMS, or FTP, to transmit data between computing devices. In some embodiments, the network 140 may include Bluetooth or near-field communication (NFC) technologies or protocols for local communications between computing devices. The network 140 may transmit encrypted or unencrypted data.

The remote system 130 communicates with the on-cart computing system 110 of the shopping cart to provide an automated checkout experience for the user. The remote system 130 may facilitate the user's payment for the items in the shopping cart. For example, the remote system 130 may receive the user's shopping list from the shopping cart and charges the user for the cost of the items in the cart. The remote system 130 may communicate with other systems to execute the transaction, such as a computing system of the retailer or of a financial institution. The remote system 130 may receive payment information from the shopping cart 100 and uses that payment information to charge the user for the items. Alternatively, the remote system 130 may store payment information for the user in user data describing characteristics of the user. The remote system 130 may use the stored payment information as default payment information for the user and charge the user for the cost of the items based on that stored payment information.

In some embodiments, the remote system 130 establishes a session for a user to associate the user's actions with the shopping cart 100 to that user. The user may establish the session by inputting a user identifier (e.g., phone number, email address, username, etc.) into a user interface of the remote system 130. The user also may establish the session through the client device 120. The user may use a client application operating on the client device 120 to associate the shopping cart 100 with the client device 120. The user may establish the session by inputting a cart identifier for the shopping cart 100 through the client application, e.g., by manually typing an identifier or by scanning a barcode or QR code on the shopping cart 100 using the client device 120. In some embodiments, the remote system 130 establishes a session between a user and a shopping cart 100 automatically based on sensor data from the shopping cart 100 or the client device 120. For example, the remote system 130 may determine that the client device 120 and the shopping cart 100 are in proximity to one another for an extended period of time, and thus may determine that the user associated with the client device 120 is using the shopping cart 100.

The remote system 130 may also provide content to the on-cart computing system 110 to display to the user while the user is operating the shopping cart. For example, the remote system 130 may use stored user data associated with the user of the shopping cart to select content that the user is most likely to interact with. The remote system 130 may transmit that content to the on-cart computing system for display to the user. The remote system 130 may also provide other data to the on-cart computing system. For example, the remote system 130 may store item data describing items in the store and the remote system 130 may provide that item data to the on-cart computing system for the on-cart computing system to use to identify items.

In some embodiments, a user who interacts with the shopping cart 100 or the client device 120 may be an individual shopping for themselves or a shopper for an online concierge system. The shopper is a user who collects items from a store on behalf of a user of the online concierge system. For example, a user may submit a list of items that they would like to purchase. The online concierge system may transmit that list to a shopping cart 100 or a client device 120 used by a shopper. The shopper may use the shopping cart 100 or the client device 120 to add items to the user's shopping list. When the shopper has gathered the items that the user has requested, the shopper may perform a checkout process through the shopping cart 100 or client device 120 to charge the user for the items. U.S. Pat. No. 11,195,222, entitled “Determining Recommended Items for a Shopping List,” issued Dec. 7, 2021, describes online concierge systems in more detail, which is incorporated by reference herein in its entirety.

### Single-Structure For Item Containment

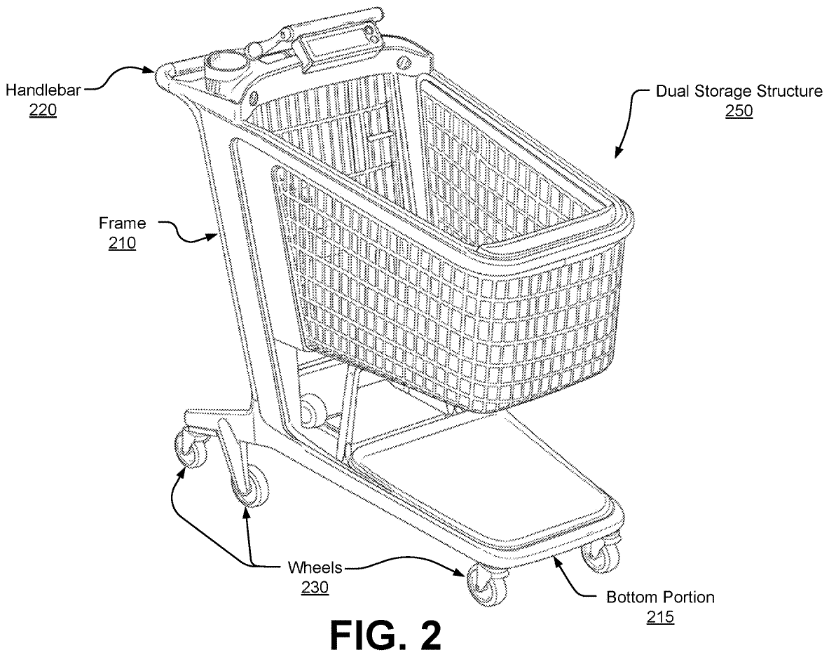

FIG. 2 illustrates an example smart shopping cart including a dual storage structure 250, in accordance with some embodiments. Alternative embodiments may include more, fewer, or different components from those illustrated in FIG. 2 and the components may be arranged or configured differently from the embodiment illustrated in FIG. 2.

The shopping cart includes a frame 210 that provides a common structure to which components of the shopping cart may be coupled. For example, cameras and load sensors may be coupled to the frame. In some embodiments, the shopping cart includes a handlebar 220. The handlebar may be rigidly coupled to the frame such that the user can control the motion of the shopping cart using the handlebar. The shopping cart includes a battery that provides power to components of the shopping cart. Examples of battery compositions include lithium-ion, lead-acid, and lithium polymer batteries.

The shopping cart may include a set of wheels 230 coupled to a bottom portion 215 of the frame. For example, the shopping cart may include a pair of rear wheels and a pair of front wheels, where at least one of the pair of wheels can swivel about an axis orthogonal to a common plane of the wheels. In some embodiments, the shopping cart includes an extra pair of rear wheels, such as where the rear wheels are located in front of the handlebar. Example shopping carts with forward-positioned rear wheels are described in U.S. patent application Ser. No. 19/242,650, entitled “Shopping Cart with Forward-Positioned Rear Wheels” and filed Jun. 18, 2025, which is incorporated by reference.

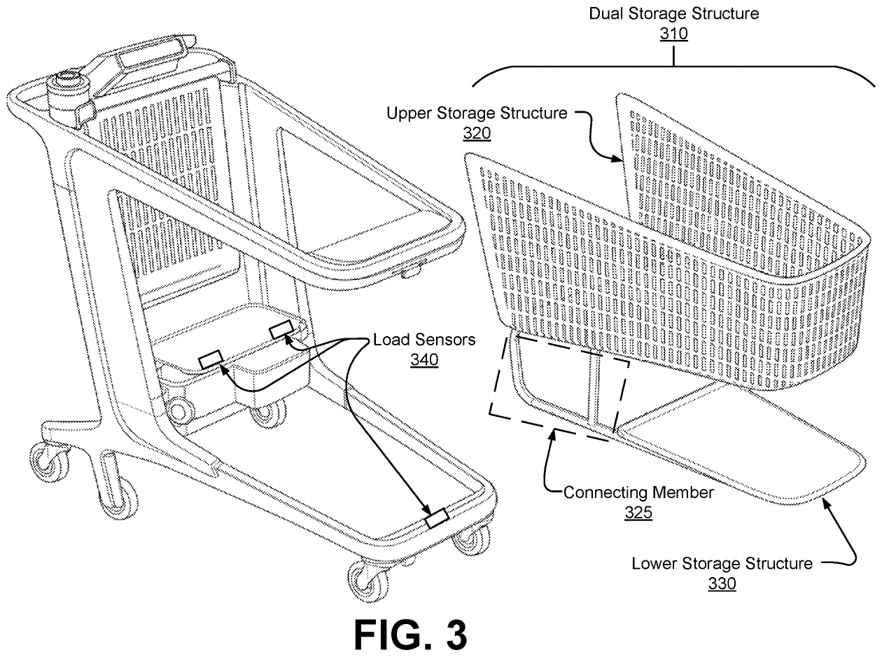

FIG. 3 illustrates an exploded view of an example smart shopping cart with a dual-storage structure 310, in accordance with some embodiments. Alternative embodiments may include more, fewer, or different components from those illustrated in FIG. 3 and the components may be arranged or configured differently from the embodiment illustrated in FIG. 3.

The shopping cart includes a dual storage structure. A dual storage structure is a singular structure for an upper storage area and lower storage area of the shopping cart. For example, the dual storage structure may include an upper storage structure 320 defining an upper storage area and a lower storage structure 330 defining a lower storage area. For example, the upper storage structure may be a basket and the upper storage area may be the volume within the basket. Similarly, the lower storage structure may be a tray and the lower storage area may be a volume between a top surface of the tray and a bottom surface of the upper storage area. The upper storage structure and the lower storage structure are coupled to each other through a connecting member 325. For example, the connecting member may rigidly connect the upper storage structure and the lower storage structure.

The shopping cart includes load sensors 340 that are coupled to the frame. The load sensors are also coupled to the dual storage structure such that the load sensors, together, measure the total load of the dual storage structure on the frame of the shopping cart. For example, the load sensors may be coupled between a bottom portion of the frame and a bottom surface of the lower storage structure or the upper storage structure. The load sensors may be configured to measure force imparted by the dual storage structure in a direction perpendicular to the plane defined by the wheels of the cart. For example, when the wheels are all in contact with the ground, the load sensors may measure a load due to gravity of the dual storage structure.

In preferred embodiments, the load sensors are configured to measure the total load of the dual storage structure on the frame of the cart. The total load includes a load of the dual storage structure itself as well as a load of items contained within the storage areas of the dual storage structure. The load may be caused due to gravity for all items contained within the dual storage structure. To measure the total load, the dual storage structure may be coupled to the frame only through the load sensors.

The on-cart computing system of the shopping cart is communicatively coupled to the load sensors such that the on-cart computing system receives signals representing the measurements of the total load from the load sensors. The dual storage structure of the shopping cart allows the on-cart computing system to measure the contents stored in both storage areas of the shopping cart.

While FIG. 3 depicts an embodiment where the upper storage structure and the lower storage structure are each coupled to load sensors, the dual storage structure may be coupled to the load sensors of the shopping cart alternative ways. For example, the upper storage structure may be not directly coupled to the frame of the shopping cart, and may only be directedly coupled to the connecting member. In these embodiments, the upper storage area may only be coupled to the frame through the lower storage structure or the connecting member. Similarly, the dual storage structure as a whole may be directly coupled to the load sensors and not directly coupled to the frame of the shopping cart. As such, the dual storage structure may be constrained substantially along the longitudinal axis and latitudinal axis of the shopping cart by the frame such that vertical movement of the dual storage structure is allowed.

### Lower Storage Area Camera

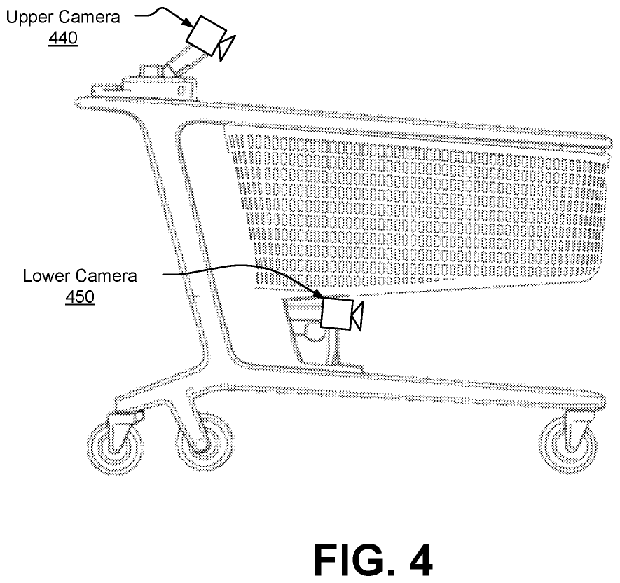

FIG. 4 illustrates a side view of an example smart shopping cart including an upper camera 440 and a lower camera 450 in view of an upper storage area and a lower storage area, respectively, of a shopping cart, in accordance with some embodiments. Alternative embodiments may include more, fewer, or different components from those illustrated in FIG. 4 and the components may be arranged or configured differently from the embodiment illustrated in FIG. 4.

The shopping cart includes a lower camera and an upper camera. The upper camera is coupled to the frame such that an upper portion, including the upper storage area, of the shopping cart is in the field of view of the upper camera. Similarly, the shopping cart includes a lower camera coupled to the frame such that a lower portion of the shopping cart, including the lower storage area, is in the field of view of the lower camera. The lower camera may be coupled to a rear portion of the frame such that the lower camera is pointed forwards. In some embodiments, the shopping cart includes additional cameras, such as a rear-facing camera coupled to the frame of the shopping cart.

The fields of view of the upper camera and the lower camera may cover parts of the environment around storage areas of the shopping cart. For example, the field of view of the lower camera may include portions of the environment extending beyond the bounds of the lower storage area, such as the floor or ground around the shopping cart. In some embodiments, the lower camera is a wide-angle camera with a field of view that covers the lower storage area and the environment of the shopping cart around the lower storage area. Similarly, the field of view of the upper camera may cover the environment around the upper storage area, such as shelves of aisles around the shopping cart or the user of the shopping cart (e.g., the edges of a tray).

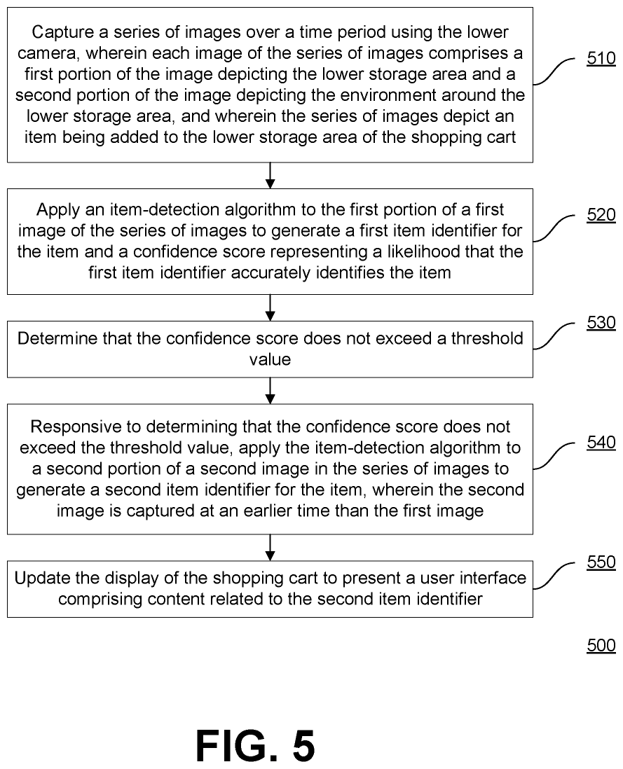

FIG. 5 is a flowchart showing a process 500 for predicting an item identifier of an item added to a lower storage area of a shopping cart using a lower camera, in accordance with some embodiments. Alternative embodiments may include more, fewer, or different steps from those illustrated in FIG. 5, and the steps may be performed in a different order from that illustrated in FIG. 5. These steps may be performed by the shopping cart (e.g., shopping cart 100), by an online system (e.g., remote system 130), or a combination of both. Additionally, each of these steps may be performed automatically without human intervention.

The shopping cart captures 510 a series of images over a time period using the lower camera. The series of images depict an item being added to the lower storage area of the shopping cart. Each image of the series of images includes a first portion of the image depicting the lower storage area and a second portion of the image depicting the environment around the lower storage area. Each image may be associated with a timestamp at which the image was captured.

The shopping cart may identify the portion of the image depicting the lower storage area using computer vision techniques to delineate the boundary between the lower storage area and the environment around the lower storage area. In some embodiments, the shopping cart uses a machine-learning model to identify portions of each image of the series of images. For example, the shopping cart may generate a bounding box for the portion of the image depicting the lower storage area using a machine-learning model trained to identify those portions in images. Similarly, the shopping cart may use a mask that indicates which pixels in images captured by the lower camera correspond to the portion of the image depicting the lower storage area.

The shopping cart attempts to detect and identify items added to the lower storage area. In an initial attempt to detect an item, the shopping cart applies 520 an item-detection algorithm to the portion of the image depicting the lower storage area. In some embodiments, the shopping cart applies an item-detection model to the entire image. The item-detection algorithm outputs a predicted item identifier for the item and an associated confidence score. The confidence score represents the likelihood that the item identifier accurately identifies the item depicted in the lower storage area. Lower confidence scores indicate that the predicted item identifier is likely incorrect, while higher confidence scores indicate that the predicted item identifier is likely correct. The shopping cart can thereby use the confidence score output with the predicted item identifier to determine whether the shopping cart has sufficient information to correctly identify the item.

The item-detection algorithm may predict the item identifier and the confidence score using a machine-learning model. For example, the item-detection algorithm may use a machine-readable code detection model, which is a machine-learning model that is trained to decode machine-readable codes that are depicted in images. The item-detection algorithm may use other sensor data captured by the cart, such as load sensor data, inertial measurement unit data, or proximity data. The item-detection algorithm may use a sensor fusion model to predict the item identifier. For example, the sensor fusion model may be a probabilistic model that predicts a likelihood of a candidate item identifier being accurate based on input sensor data. Example item-detection algorithms are described in U.S. patent application Ser. No. 18/772,782, filed Jul. 15, 2024 and U.S. patent application Ser. No. 17/703,076, filed Mar. 24, 2022, each of which are incorporated by reference.

To determine whether the item-detection algorithm can identify the item in the first portion of the image of the lower storage area, the shopping cart compares 530 the confidence score to a threshold value to assess the quality of the prediction. The threshold value establishes an allowable threshold for error in the prediction. If the confidence score exceeds the threshold value, the shopping cart uses the predicted item identifier as the item identifier for the item. For example, the shopping cart may display content relating to the item associated with the predicted item identifier on a display of the shopping cart. In some embodiments, if the confidence score exceeds the threshold value, the shopping cart makes no further attempts to detect and identify the item.

However, if the confidence score does not exceed the threshold value, the shopping cart will attempt to identify the item as it approaches the lower storage area by applying 540 the item-detection algorithm to an earlier image in the series of images. For example, the shopping cart may identify an image captured at an earlier timestamp than the image used to generate the predicted item identifier and confidence score. The shopping cart may apply the item-detection algorithm to this earlier image to determine whether it can identify the item.

The shopping cart may apply a similar process to the second image as to the first image to generate a new predicted item identifier and a new confidence score. For example, the shopping cart may apply the same item-detection algorithm to the second image. In some embodiments though, while the shopping cart applies the item-detection algorithm to only a portion of the first image depicting the storage area, the shopping cart applies the item-detection to the full second image or at least to a portion of the second image depicting the environment around the shopping cart. Furthermore, in some embodiments, the shopping cart may apply the item-detection algorithm to both the first image and the second image.

While an item in the lower storage area may be identifiable using a first or second image from a series of images captured by the lower camera, the shopping cart may apply the item-detection algorithm to any image in the series. In some embodiments, the shopping cart applies the item-detection algorithm to the portion of the image depicting the storage area for multiple images in the series of images. Similarly, the shopping cart may apply the item-detection algorithm to the whole image of multiple images of the series. The shopping cart may apply the item-detection algorithm to generate an item identifier and confidence score for multiple images of the same series for more robust prediction of the item. For example, the predicted item identifier may be selected based on an aggregate of outputs from the item-detection algorithm.

The shopping cart determines whether it can identify the item using the new predicted item identifier based on the confidence score with the new item identifier. For example, the shopping cart compares the associated confidence score to a threshold value. If the confidence score exceeds the threshold value, the shopping cart may consider this item identifier to be representative of the item in the lower storage area and use it for subsequent actions related to the item.

Upon positively identifying an item using the lower camera, the shopping cart updates 550 a display of the shopping cart (e.g., the primary display). The display is updated to present a user interface including content related to the predicted item identifier. As described above, the predicted item identifier may have been generated using the portion of an image depicting the lower storage area or its surrounding environment captured by the lower camera.

In some cases, the shopping cart may still fail to identify the item using images captured by the lower camera. For example, a user may add an item to the lower storage area in such a way that a portion of the user's body obfuscates the item (e.g., the user's arm blocks the view of the item for the lower camera). In another example, a user may add an item to the lower storage area too quickly for the lower camera to detect (e.g., an item is tossed into the lower storage area).

In these cases, the shopping cart may use images captured using the upper camera. The upper camera has a field of view covering the environment of the shopping cart around the upper storage area and may include movement of a user. As such, the upper camera may capture images depicting a user adding an item to the lower storage area. For example, an image may be captured by the upper camera when a user stands to the side of the shopping cart and adds an item to the lower storage area.

In some embodiments, the upper camera captures a second series of images over the same time period as the first series of images. Each image of the second series of images depicts the environment of the shopping cart around the upper storage area and the lower storage area. The second series of images may depict the item being added to the lower storage area of the shopping cart based on the movement of a user. In some embodiments, the first image in the second series of images is captured at an earlier timestamp than the first image of the first series of images.

The shopping cart may apply an item-detection algorithm to the second series of images to identify the item being added to the lower storage area. Similar to the process of detecting items using the lower camera, the item-detection algorithm outputs a predicted item identifier and an associated confidence score. If the confidence score exceeds a threshold value, the shopping cart may determine that the item has been positively identified using the series of images captured by the upper camera.

In the process of generating predicted item identifiers using the upper or lower cameras, the shopping cart may apply the same item-detection algorithm or different algorithm for different portions of an image captured in the series of images (e.g., an attention mechanism may be used for some portions). The shopping cart may apply different item-detection algorithms to images at different stages (e.g., identifying items depicted in a first or second portion of an image) of the item identification process. In some embodiments, the shopping cart applies the same item-detection algorithm at all stages of the item identification process. For example, the shopping cart may apply a convolutional neural network trained to identify items to a portion of the image depicting the lower storage area and a sliding window method algorithm to a portion of an image depicting the environment around the lower storage area.

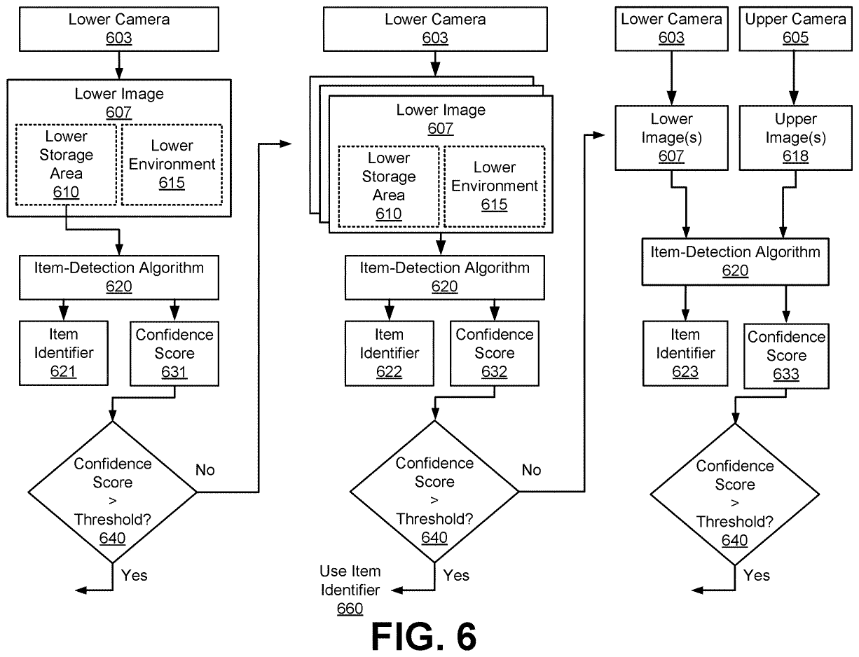

FIG. 6 illustrates an example data flow for predicting an item identifier of an item added to a lower storage area of a shopping cart by using images captured by a lower camera, in accordance with some embodiments. Alternative embodiments may include more, fewer, or different steps from those illustrated in FIG. 6, and the steps may be performed in a different order from that illustrated in FIG. 6. These steps may be performed by the shopping cart (e.g., shopping cart 100), by an online system (e.g., remote system 130), or a combination of both. Additionally, each of these steps may be performed automatically without human intervention.

The shopping cart attempts to identify an item added to the lower storage area using a lower image 607 from the lower camera 603. Each image captured by the lower camera includes a portion 610 of the image depicting the lower storage area and a portion 615 of the image depicting the environment surrounding the lower storage area. The shopping cart attempts to identify the item by applying an item-detection algorithm 620 to the portion 610 depicting the lower storage area. The item-detection algorithm outputs a predicted item identifier 621 and an associated confidence score 631 representing the likelihood the likelihood that the item identifier accurately identifies the item. The shopping cart compares 640 the confidence score to a threshold value to determine whether to use the item identifier. If the confidence score exceeds the threshold value, the shopping cart uses 650 the predicted item identifier 621 as the item identifier for the item (e.g., to present content relating to the item to the user).

If the confidence score does not exceed the threshold value, the shopping cart attempts to identify the item as it approaches the lower storage area by applying the item-detection algorithm to an earlier image in the series of images. The shopping cart applies the item-detection algorithm to at least one image captured by the lower camera earlier in a series of images depicting the environment around the lower storage area. The item-detection algorithm outputs another predicted item identifier 622 and another associated confidence score 632 representing the likelihood that the item identifier accurately identifies the item. The shopping cart compares the new confidence score 632 to a threshold value to determine whether to use the new item identifier 622. If the confidence score exceeds the threshold value, the shopping cart uses 660 the predicted item identifier 622 as the item identifier for the item.

If the confidence score does not exceed the threshold value, the shopping cart attempts to identify the item as it approaches the lower storage area using the upper camera 605. The shopping cart applies an item added to the lower storage area to at least one image 618 captured by the upper camera. The shopping cart may also input lower images 607 captured by the lower camera to the item-detection algorithm 620 along with the upper images 618. The item-detection algorithm outputs a predicted item identifier 623 and an associated confidence score 633 representing the likelihood that the item identifier accurately identifies the item. The shopping cart compares the confidence score to a threshold value to determine whether to use the new item identifier 623. If the confidence score exceeds the threshold value, the shopping cart uses 670 the predicted item identifier 623 as the item identifier for the item.

### Generating Content For A Secondary Display

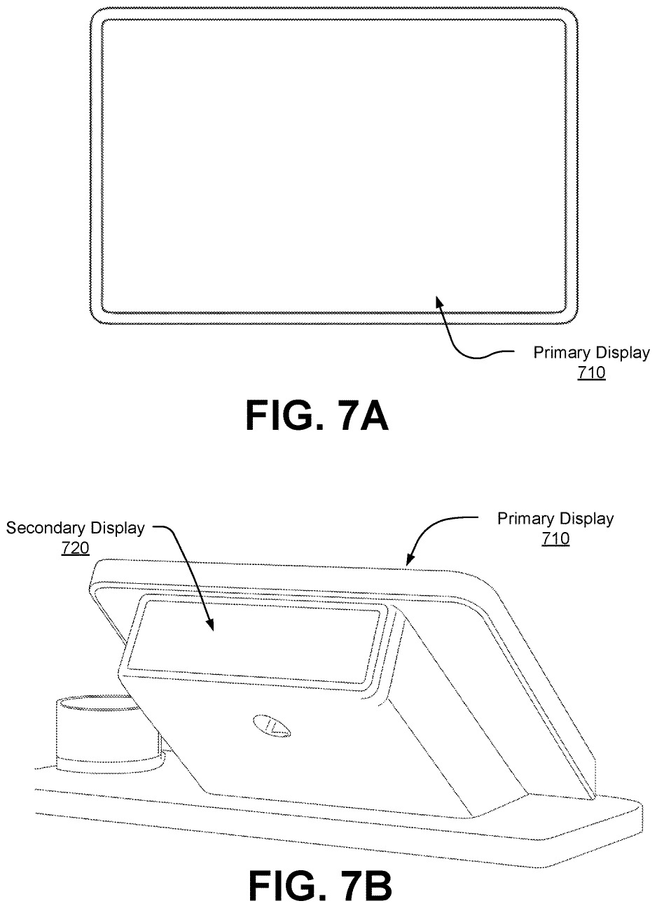

FIGS. 7A and 7B illustrate an example smart shopping cart including a primary display 710 and a secondary display 720, in accordance with some embodiments. Alternative embodiments may include more, fewer, or different components from those illustrated in FIGS. 7A and 7B and the components may be arranged or configured differently from the embodiment illustrated in FIGS. 7A and 7B.

The shopping cart includes a primary display that presents information relating to the user's interactions with the shopping cart. An example primary display is illustrated in FIG. 7A. The primary display may be coupled to a handlebar, the upper storage area, or the frame of the shopping cart and may face towards the handlebars of the shopping cart. The on-cart computing system displays content on the primary display. The primary display displays a primary UI containing UI panes that are associated with a user's interaction with the shopping cart and sensor data received from the shopping cart. For example, UI panes of the primary UI may be updated based on events including item detection and the location of the shopping cart in the environment.

The shopping cart includes a secondary display that is directed towards the storage area of the shopping cart. The secondary display may be smaller than the primary display and may be a different type of display from the primary display. For example, the primary display may be a touchscreen while the secondary display is not a touchscreen. Example types of displays include light emitting diode (LED) displays, organic light emitting diode (OLED) displays, liquid crystal displays (LCD), electronic paper displays, and segmented displays.

The secondary display presents supplemental content relating to a user's interactions with the shopping cart. For example, the secondary display may present content describing items that the user added to a storage area of the cart or may display suggestions for recipes or items for the user to display. The secondary display may display content based on the content presented on the primary display. For example, the on-cart computing system may select a subset of content shown on the primary display to display on the secondary display.

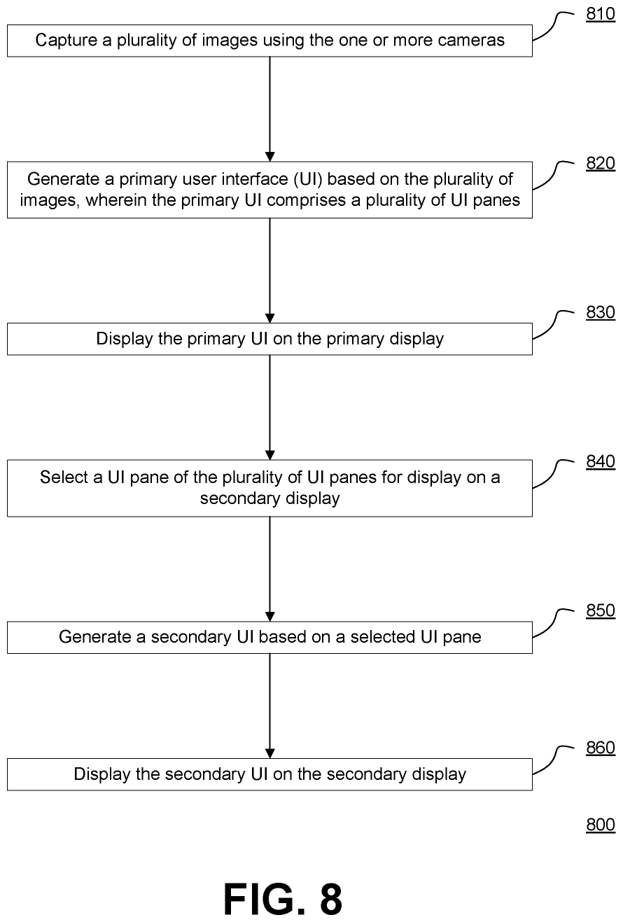

FIG. 8 is a flowchart for a process 800 for generating a user interface for a secondary display of a shopping cart based on content selected from a primary display of the shopping cart, in accordance with some embodiments. Alternative embodiments may include more, fewer, or different steps from those illustrated in FIG. 8, and the steps may be performed in a different order from that illustrated in FIG. 8. These steps may be performed by the shopping cart (e.g., shopping cart 100), by an online system (e.g., remote system 130), or a combination of both. Additionally, each of these steps may be performed automatically without human intervention.

The shopping cart captures 810 images using cameras coupled to the shopping cart. The images depict one or more storage areas of the shopping cart. For example, the shopping cart may use an upper camera to capture images of an upper storage area or a lower camera to capture images of a lower storage area. These images may also depict items within the storage areas of the shopping cart. In some embodiments, the cameras capture a series of images over a period of time. For example, the shopping cart may capture the series of images in response to detecting that an item was added to a storage area of the shopping cart.

The shopping cart generates 820 a primary UI for the primary display of the shopping cart and displays 830 the primary UI on the primary display. The primary UI includes a set of UI panes that depict content relating to the user's interactions with the shopping cart. For example, the primary UI may include an item list UI panes describing an item added to a storage area, a navigation UI pane describing a route through an environment to reach a location, a recommendation UI pane that recommends items for collection by the user, and search UI panes that allow a user to submit a query (e.g., text or speech) to the on-cart computing system.

The shopping cart generates content for the UI panes based on the captured images. For example, the shopping cart may use the images to identify items within a storage area of the shopping cart and generate content relating to the identified items for display in a UI pane. Similarly, the shopping cart may use the images to predict a location of the shopping cart within the environment and may select a UI pane for presentation in the primary UI based on predicted location.

The shopping cart generates content for the UI panes based on other data collected by the cart. For example, the shopping cart may collect data describing the user's interactions with the shopping cart and may select which UI panes to include or what content to include in the UI panes based on the collected data. Similarly, the shopping cart may capture sensor data using sensors of the shopping cart to generate the UI panes for the primary UI. For example, the shopping cart may detect when a user adds an item to a storage area of the shopping cart based on load sensor data and may update the UI panes based on the detection of the item. Similarly, the shopping cart may detect user interactions with the display and update the UI panes.

In many embodiments, the secondary display is smaller than the primary display, so the shopping cart may select a subset of the content on the primary display for presentation on the secondary display. For example, the shopping cart may select 840 a UI pane from the primary UI for display on the secondary display. The shopping cart may select the UI pane based on the images captured by the shopping cart. For example, the shopping cart may select a UI pane that displays information about an item added to a cart based on an item identified in the captured images. Similarly, the shopping cart may identify a position of the user relative to the shopping cart based on the captured images and may use the pose to detect whether the user can view the secondary display. The shopping cart may select a UI pane for the secondary display based on whether the user can view the secondary display.

The shopping cart may select the UI pane based on user interactions with the cart. For example, a user may interact with a UI pane in the primary UI to highlight that UI pane and the shopping cart may select the highlighted UI pane for display on the secondary display. Similarly, a user may interact with a search UI pane on the primary display to locate and navigate to an item within the environment, and the shopping cart may select a navigation UI pane while the user is navigating to the item.

The shopping cart generates 850 the secondary UI based on a selected UI pane. The shopping cart may alter the selected UI pane for display on the secondary display. For example, the shopping cart may add, replace, or remove UI elements from the select UI pane. For example, a UI pane in the secondary UI may contain a subset of recommended items from an item recommendation UI pane. Similarly, the shopping cart may change the arrangement, scale, or aspect ratio of UI elements in the selected UI pane or change of the UI pane as a whole.

The shopping cart displays 860 the generated secondary UI on the secondary display. For example, the shopping cart may immediately display the secondary UI upon generating the secondary UI. Alternatively, the shopping cart may display the secondary UI in response to a timing event. For example, the timing event may be simply some point in time after generation of the secondary UI and the shopping cart displays the secondary UI when that point in time occurs. Similarly, the timing event may be based on data collected by the shopping cart. For example, the timing event may be a detection of the user within a viewing angle of the secondary display such that the shopping cart displays the secondary UI in response to detecting the user within that viewing angle. The shopping cart may use images captured by cameras or sensor data captured by sensors of the shopping cart to detect whether the user is within a viewing angle of the secondary display.

The shopping cart may display the secondary UI with the selected UI pane for a period of time. After the period of time, the shopping cart may deactivate the secondary display or update the display to present a default UI. In some embodiments, the shopping cart displays a default UI pane from the primary UI at the end of the period of time. The shopping cart may display the default UI on the secondary display until the shopping cart generates another secondary UI. The shopping cart may update the default UI pane displayed on the secondary display based on updates to that UI pane on the primary UI. For example, if the default UI pane is an item list describing items in the shopping cart, the shopping cart may update the default UI pane on the secondary UI as the shopping cart updates that UI pane on the primary UI.

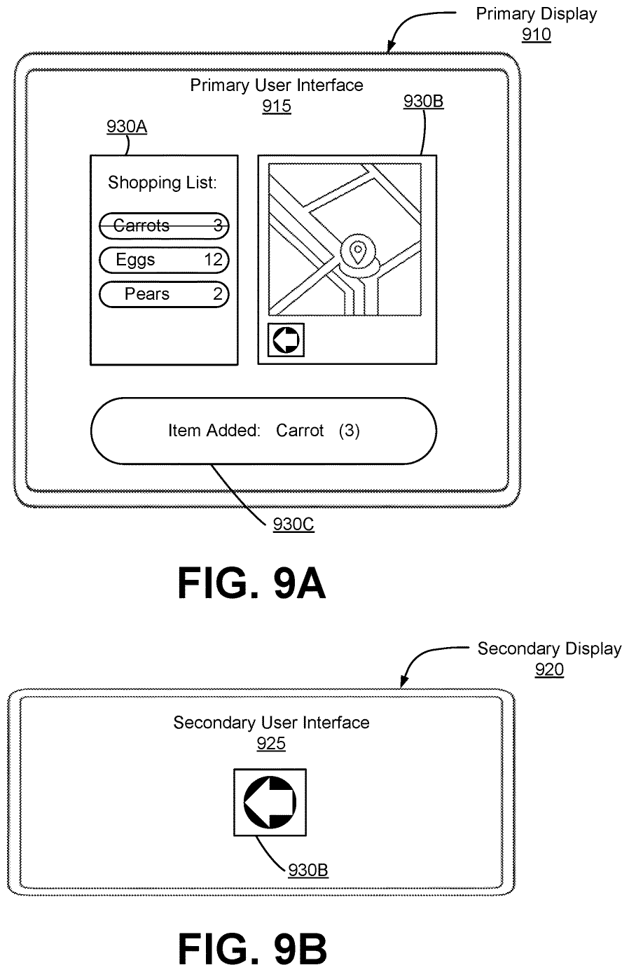

FIGS. 9A and 9B illustrate an example of a primary UI 915 displayed on a primary display 910 and a corresponding secondary UI 925 containing a navigation UI pane 930B displayed on a secondary display 920, in accordance with some embodiments. Alternative embodiments may include more, fewer, or different components from those illustrated in FIGS. 9A and 9B and the components may be arranged or configured differently from the embodiments illustrated in FIGS. 9A and 9B.

A primary user interface is displayed on a primary display. In some embodiments, the primary UI includes multiple UI panes 930. The exemplary primary UI illustrated in FIG. 9A includes a shopping list UI pane 930A, a navigation UI pane 930B, and an item list UI pane 930C. Each UI pane depicts content based on sensor data or user interactions with the shopping cart. The shopping list UI pane contains item names and quantities retrieved from the on-cart computing system. In some embodiments, items of the shopping list UI pane are added or removed dynamically (e.g., crossed out or replaced) by the on-cart computing system based on items being added to the shopping cart. The navigation UI pane contains the location of the shopping cart at a location and turn-by-turn directions based on a destination (e.g., an item at the location). The item list UI pane contains information related to an item added to one of the storage areas, including the item name and quantity.

The second UI 925 illustrated in FIG. 9B includes a navigation UI pane 930B. In this illustrative example, the navigation UI pane generated for the secondary display contains an unaltered portion of the selected navigation UI pane of the primary UI.

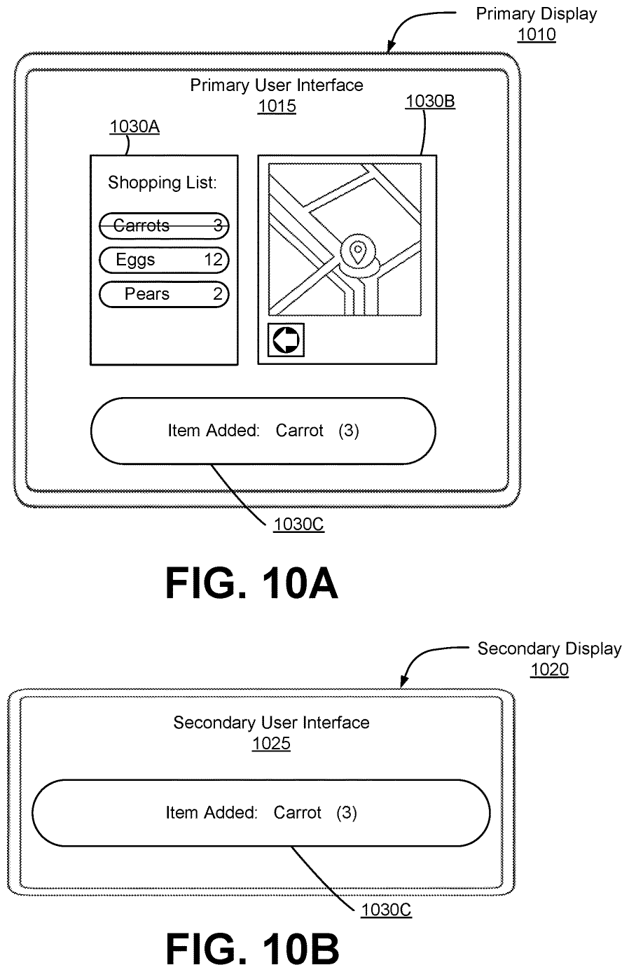

FIGS. 10A and 10B illustrate an example of a primary user interface 1015 displayed on a primary display 1010 and a corresponding secondary user interface 1025 containing an item list user interface pane 1030C displayed on a secondary display 1025, in accordance with some embodiments.

The second UI 1025 illustrated in FIG. 10B includes an item list UI pane 1030C. In this illustrative example, the item list UI pane contains the same information as depicted in both the primary UI and secondary UI. However, the item list UI pane generated for the secondary UI is horizontally scaled in comparison to the UI pane generated for the primary UI. As such, the item list UI pane is altered to fit the aspect ratio of the secondary display.

### Other Considerations

The foregoing description of the embodiments has been presented for the purpose of illustration; it is not intended to be exhaustive or to limit the scope of the disclosure. Many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some embodiments, a software module is implemented with a computer program product comprising one or more computer-readable media containing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to an apparatus for performing the operations herein. This apparatus may be specially constructed for the required purposes, or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The weights may be stored on one or more computer-readable media, and are used by a system when applying the machine-learning model to new data.

The language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C having at least one element in the combination that is true (or present). As a not-limiting example, the condition “A, B, or C” is satisfied by A and B are true (or present) and C is false (or not present). Similarly, as another not-limiting example, the condition “A, B, or C” is satisfied by A is true (or present) and B and C are false (or not present).

What is claimed is:

1. A shopping cart comprising:
a frame comprising a bottom portion and a plurality of wheels coupled to the bottom portion;
a dual storage structure comprising:
an upper storage structure;
a lower storage structure; and
a connecting member rigidly connecting the upper storage structure and the lower storage structure;
a load sensor, wherein the load sensor is coupled between the bottom portion of the frame and the lower storage structure of the dual storage structure to sense a total load placed in the upper storage structure and the lower storage structure of the dual storage structure; and
a computing system that is communicatively coupled to the load sensor, wherein the computing system is configured to receive a signal representing the sensed total load from the load sensor.

2. The shopping cart of claim 1, further comprising a plurality of load sensors that are coupled between the bottom portion of the frame and the lower storage structure of the dual storage structure to sense the total load placed in the upper storage structure and the lower storage structure of the dual storage structure.

3. The shopping cart of claim 1, wherein at least one load sensor is coupled between the frame of the shopping cart and the upper storage structure.

4. The shopping cart of claim 1, further comprising an upper camera coupled to the upper storage structure and a lower camera coupled to the lower storage structure.

5. The shopping cart of claim 1, wherein the upper storage structure is a basket.

6. The shopping cart of claim 1, wherein the lower storage structure is a tray.

7. The shopping cart of claim 1, wherein the computing system comprises a non-transitory computer-readable medium storing instructions that, when executed by the computing system, cause the computing system to perform operations comprising:
receiving, by the computing system, the signal from the load sensor measuring a sensed total load of the dual storage structure; and
detecting that an item was added to the upper storage structure or the lower storage structure of the dual storage structure based on the sensed total load.

8. The shopping cart of claim 7, the operations further comprising:
identifying the item based on the sensed total load of the dual storage structure.

9. The shopping cart of claim 8, wherein the shopping cart further comprises an upper camera coupled to the upper storage structure and a lower camera coupled to the lower storage structure, the operations further comprising:
receiving an upper image depicting the upper storage structure from the upper camera;
receiving a lower image depicting the lower storage structure from the lower camera; and
identifying the item based on the upper image or the lower image.

10. The shopping cart of claim 9, the operations further comprising:
determining whether the item is located in the upper storage structure or the lower storage structure based on the upper image or the lower image.
